(19) United States
(12) Patent Application Publication
(10) Pub. No.: US 2020/0367500 A1
(43) Pub. Date: Nov. 26, 2020

(54) MICROCAPSULES WITH BIOCIDES FOR THEIR INCORPORATION INTO REPELLENT AND/OR INSECTICIDE COATINGS

(71) Applicant: Supernova Coatings SA DE CV, Cuajimalpa de Morelos, Cd. De Mexico (MX)

(72) Inventors: JOSE MARIA RIBOT BARROSO, Cuajimalpa de Morelos Cd. De Mexico (MX); BERNARDO AGUSTIN MENDOZA FLORES, Cuajimalpa de Morelos Cd. De Mexico (MX)

(73) Assignee: Supernova Coatings SA DE CV, Cuajimalpa de Morelos, Cd. De Mexico (MX)

(21) Appl. No.: 16/831,837

(22) Filed: Mar. 27, 2020

(30) Foreign Application Priority Data
May 24, 2019 (MX) MX/A/2019/006096

(51) Int. Cl. A01N 47/12; A01N 37/10; A01N 25/28

(52) U.S. Cl. CPC A01N 47/12; A01N 25/28; A01N 37/10

(57) ABSTRACT

This invention refers to microcapsules with biocide for their incorporation into coatings such as paint or similar repellents and/or insecticides, characterized by containing carbamate alone or combined with a pyrethroid such as deltamethrin as active ingredient (biocide), where such microcapsules are designed for a greater stability and an extended release of the active ingredient, where such microcapsules are produced through a method selected from an inclusion method using β-cyclodextrin or dextrin-chitosan-melamine, a simple coacervation method, a complex coacervation method and a melamine-chitosan microencapsulation method, where these are added to the coating in ratios from 1% to 6% of coating weight, from 1% to 25% of coating weight, from 1% to 50% of coating weight, or 2% to 37% of coating weight.

### FIELD OF INVENTION

This invention is related to chemistry in general, and it is specifically related to the technological development field in relation to microencapsulation of insect repellent substances, applied to coatings and, more specifically, it refers to the formulation and manufacturing of microcapsules with biocide, for their incorporation in repellent and/or insecticide coatings and paints.

### INVENTION BACKGROUND

Insects play an essential role in environmental functions. They are the main predators of other invertebrates and thus, they control plagues. They decompose and eliminate a significant percentage of organic matter, and they are the main plant pollinators of ecological and economic relevance. Nevertheless, and sometimes due to their high abundance, they are considered a harmful group, as they consume around one third of crops at a global level, and they are the main carriers of human diseases (Brusca and Brusca, 2002).

Insects have coexisted with human beings forever, and they are a part of the ecological balance of the planet, as they represent food for birds, reptiles and even other insects. On the other hand, many of them carry diseases, such as dengue, the Chagas disease, zika, chikungunya, yellow fever, malaria, among other diseases; thus, it is very important to control them.

Almost close to one million named species, and some unnamed ones, insects comprise most animal species on Earth. The populations of this group cover the space where they settle, they are found in all land and freshwater habitats, from the driest desserts to freshwater ponds, from the upper part of a humid tropical forest all the way to the Arctic's waste. Their diversity is greater than any other animal classification. Only a few species are marine. Their eating habits are quite diverse, any element or substance with a nutritional value is eaten by one of their groups. They have an immense variety of shapes, and they do not grow to a significant size.

They share a series of characteristics with most alive insects, such as: A body comprised by three parts: head, thorax, abdomen, a pair of relatively big eyes and three ocelli on the top of the head, a couple antennas, a couple jaws, a couple maxilla, one lip and a hypo-pharynx in the shape of a tongue, two pairs of wings derived from excrescences of the body walls, and three pairs of legs.

Insects possess a full and complex digestive system, their mouth pieces are especially variable, often complex and related to their eating habits. They breathe through a tracheal system with outer openings called spiracles and tubules that grow finer and finer that carry gas to metabolizing tissue. Aquatic forms can exchange gas through body walls, or they can carry this out through Malpigui tubules. Their nervous system is complex, including several ganglia and a ventral cord with a double nerve. Ganglia are independent in their functioning; for example, an isolated thorax is able to keep walking. A grasshopper with one wing removed can correct this loss and keep flying by using sensorial stimuli in their brains. Sense organs are complex and acute, and they also have ocelli and compound eyes. Some insects are sensitive to sound, and their chemoreceptive skills are outstanding.

Insect reproduction often requires a male locating a receptive female through pheromones released by the female. In most species, females store sperm in a special receptacle in their abdomen, even the species that lay significant amounts of eggs. In bees, it can be even one million, females only mate once, and they rely on the sperm stored during mating for the rest of their lives. The way in which growth takes place is particularly important in insects, in some cases, eggs produce ‘mini-adults’, which must detach from their exoskeleton to grow, in a process called ecdysis. In almost 90% of insect species, newborns are completely different, in appearance, from adults.

These larva forms live in different habitats and eat different food and they take forms that are completely different from their parents. Larvae feed and periodically change their skin. At some point, larval growth is complete, the larva stops feeding, and it builds a case or cocoon around itself. In this condition, it is called a pupa or chrysalis. While the larva is trapped, it suffers a full transformation or metamorphosis of its bodily shape, and a fully transformed adult comes out. Insects that experience this type of change are called holometabolic, other species are subject to a more gradual process in which the newly hatched looks more like adults, but in a smaller size, with no wings, and sexually immature.

There are several insect control methods, such as biological control, chemical control (insecticides, pesticides, acaricides, nematicides, systemic and non-systemic insecticides, organic controls, among others).

There are insecticide products in the market, such as aerosols, plastic plates and tapes, anti-insect paper and paint, with several effectiveness degrees. Nevertheless, these products have a low residuality and a high cost, in addition to strong and toxic smells for humans, and some of them use pesticides as active ingredients, which can damage health. Most products that exist in the market do not comply with the duration and functionality stated on the label and, due to their high costs, they are limited to people or companies with a significant purchasing power, popular classes being at the highest risk of contagion due to insect bites.

On the other hand, microencapsulation is a technique used more and more, and its applications give rise to a growing interest in several technology fields, from agriculture to the food industry, cosmetics and pharmaceuticals, and the textile and aerospace industries.

Microcapsules release the material contained in them during the preparation of other products to potentiate, or deliver a different appearance to, the products. For example, in perfumes, essential oils are microencapsulated to create a non-liquid formulation, it is solid and applied in much lower concentrations, being more manageable.

Microencapsulation consists of applying a thin layer on small solid particles, liquid droplets or scatterings, in order to protect, separate or better handle and store materials. It can also lead to the delivery of the coated substances under specific conditions, or in a deferred, extended manner.

These conditions required for delivery can be humidity, pH, physical forces or the combination thereof. Coated particles in the microcapsules have a size from one to 500 microns. Size can be controlled in the manufacturing process.

Microencapsulation is used in order to change some physical properties of liquids or solids, in order to protect them or make them more manageable. With this technique, oily solutions can turn into solid products, and it is possible to control the delivery and modify some colloidal and surface properties of the substances coated. This also allows to mix and store substances that react or are incompatible to each other in the same container. This is also used to cover a bad taste or smell of substances, reducing the volatile characteristics of some substances.

This invention is related to the microencapsulation of compounds derived from a family of insecticides that are not pyrethroids, and its use is recommended in case of resistance to conventional insecticides, as such resistance is created when the same products is always used and insects create it, and they do not die, which makes it necessary to change the active ingredient in a formulation.

The formulation presented has been improved, due to the change in the active ingredient in the paint, precisely to avoid such natural resistance of insects to pyrethroids.

After carrying out a search to determine the closest status of the technique, the following documents were found:

U.S. Pat. No. 6,280,759B1 by Ronald R. Price et al., dated Mar. 7, 1989 was found, which relates to microtubes that contain an active ingredient in their cavity, as well as compositions that contain such microtubes, which make them efficient to provide a slow and controlled release of the active ingredient. Such microtubes are useful for the production of coating compositions to protect surfaces that are in contact with water, adhesive resins for the manufacturing of laminated wood products, and devices to deliver pesticides. Such active ingredient is one or more members selected from the group that comprises fungicides, herbicides, insecticides, pheromones, hormones, antibiotics, anthelmintic agents and anti-fouling agents.

U.S. Pat. No. 6,881,248B2 by Han Lim Lee et al, dated Dec. 10, 2002 was also found, which relates to a paint composition that can reduce the development of resistance to insecticides in insects. Such paint contains 25-mg to 50-mg of deltamethrin per liter used, as the main component, 12.5 to 1,350 mg of piperonyl butoxide per liter used, and emulsion paint as the third component.

U.S. Pat. No. 5,931,994A by Maria Pilar Mateo Herrero, dated Dec. 23, 1996, was also found, which relates to a paint composition to control plagues and allergens through a chitin synthesis inhibitor, which comprises a mix of 10 to 40% of weight in water, 5 to 50% of weight in resin, 0.001 to 40% of weight in a chitin inhibitor, 0.001 to 5% of weight if organophosphate, 1 to 40% of weight in pigment, 1 to 60% of weight in a carrier material and 1 to 20% of weight in a stabilizer, where percentages of weight are based on the total weight of the composition, where the chitin inhibitor is microencapsulated in a resin polymer.

U.S. Pat. No. 3,400,093A by Feinberg Irving, dated Mar. 11, 1966, was also found, which related to a procedure to manufacture an insecticide polymer, which requires the dissolution of, at least, one organic insecticide in, at least, one vinyl-type polymerizable monomer, such monomer, and other vinyl-type monomers, with which polymerization is carried out, which provide the predominant monomeric units to the polymer, scattering such monomer in the form of droplets through an polymerization aqueous liquid medium, in which such monomer is substantially immiscible, and in which such insecticide is substantially insoluble, and polymerizing such monomer through polymerization techniques in emulsion, and the attainment of a stable polymer latex, which contains small discrete, usually polymer solid, particles incorporated into such insecticide.

According to patent ES2539736 by Mateo Herrero Ma. Pilar, dated Jul. 3, 2015, which relates to the use of a biocide composition, without specifying the type of active ingredient, but with the characteristic of being an acaricide insecticide, fungicide algicide and arthropods repellent, inhibitor of chitin synthesis and regulator of the juvenile hormone of insects, comprised by: 0.1-75% of the total weight in biocide and 10-70% of water of the total weight of the coating formula, regardless of the color or shade, only focusing on the amount of aggregate in its composition.

Nevertheless, the products stated in the aforementioned documents show competitive disadvantages in comparison to our development, as our formulation allows the increase of effectiveness of the insecticide paint, while increasing the useful life of active ingredients.

### INVENTION OBJECTIVES

The main objective of this invention is providing microcapsules with biocides, or similar products, for their incorporation into coatings, such as repellent and/or insecticide paint, which allows the increase of effectiveness of the insecticide coating, also increasing the useful life of the microencapsulated active ingredients.

Another objective of the invention is providing microcapsules with biocides for their incorporation in coatings, such as repellent and/or insecticide paint, which also provides a stable and controlled-release product to fully leverage the advantages offered by active ingredients (biocides).

Another objective of the invention is providing microcapsules with biocides for their incorporation in coatings, such as paint or similar repellents and/or insecticides, where such biocides are less harmful for the environment, as well as biodegradable and less toxic for human beings.

Another objective of the invention is providing microcapsules with biocides for their incorporation into coatings, such as paint or similar repellents and/or insecticides, where such biocides allow the delay of insect resistance and immunity effect for a longer period.

Another objective of the invention is providing microcapsules with biocides for their incorporation in coatings, such as paint or similar repellent and/or insecticide products, which also offer a low toxicity, without affecting human beings, domestic animals and/or farm animals.

Another objective of the invention is providing microcapsules with biocides for their incorporation is coatings, such as repellent and/or insecticide paint, which also offer a more extended residual effect to repel, reduce, and control flying and crawling insects with a greater efficacy, and for a more extended period than products currently in the market can offer.

And all those objectives and advantages that will become evident by reading this description, along with the attached compositions, which are an essential part of this document.

### INVENTION DESCRIPTION

In general, microcapsules with biocides for their incorporation in coatings such as repellent and/or insecticide paint, consists in microcapsules obtained through several techniques, preferably through the simple coacervation technique, along with an extrusion process to encapsulate a biocide as active ingredient, which consists of a carbamate alone, or combined with a pyrethroid, in such a way that such microcapsules are stable and allow the extended release of the encapsulated biocide.

Carbamates include a group of artificial pesticides mainly developed to control plague insect populations.

Carbamates are organic synthesis substances formed by a nitrogen atom bound to a labile group; carbamic acid. This has a neurotoxic effect that allows the control of insects in the correct dose, they are highly toxic, with a low chemical stability, not accumulated in tissues, which offers advantages over organochloride insecticides with a low degradability and great accumulation. Carbamates are less harmful for the environment than other biocide and/or pesticide ingredients. Likewise, they are biodegradable and less toxic for human beings.

Pyrethroids are from the biocide and/or pesticide family, not toxic for mammals.

Surprisingly enough, during the development of this invention, it was found that with the use of pyrethroids, using deltamethrin along with carbamate, the insect resistance and immunity effect is delayed for a longer period, in comparison to individual carbamate microencapsulation.

Surprisingly enough, it was found that the combination of different biocides and/or pesticides in this invention, encapsulate and added to coating (paint) materials leads to an increase of the coating effectiveness as insecticide, while simultaneously increasing the useful life of active ingredients (deltamethrin plus carbamate).

The main physicochemical properties of insecticides to consider when selecting the microcapsule, are as follows:

### a.—Resistance to Alkalinity

Alkalinity is natural and common in almost all materials used for the construction of housing and thus, the foundations where insecticide paint will be applied. This factor is decisive for the application of pesticides, as most active ingredients, particularly organophosphates and carbamates, are decomposed in alkaline mediums, requiring pH between 5 and 6 to stay relatively stable (Table A).

TABLE A
Mean life of some insecticide active
ingredients in aqueous mediums.

| Active ingredient | Decomposition time (Mean life) |
|---|---|
| Diflubenzuron | Stable in a pH range from 5 to 7. Hydrolyzed at pH 9. |
| Cypermethrin | pH 9 (7 days). Stable at pH 4. Quite stable in acid |
| | solutions. |
| Deltamethrin | pH 7 (8 hours) more stable in medium acid solutions |
| | than alkaline solutions |
| D-allethrin | Stable at pH 5 after 31 days. pH 7 (500 days) pH 9 |
| | (4.3 days) |
| Chlorpyrifos | At pH 10 (7 days). Stable in neutral and slightly |
| | acid solutions. |
| Diazinon | pH 9 (136 days). pH 7.5 (185 days). pH 5 (31 days). |
| Malathion | Quickly hydrolyzed at pH over 7. The optimal pH |
| | range is between 5 and 6. |
| Permethrin | Stable at pH between 5 and 6. |
| Pirimiphos- | pH 8 (5 days). pH 5 (7 days). |
| methyl | |
| Pyriproxifen | Stable in pH between 4 and 9. |

The active ingredient microcapsule release mechanisms can be: releasing, through the microcapsule porosity, through thermal expansion, fracture, by force or pressure and friction.

This alkaline hydrolysis causes a great reduction of actual efficacy of the formulation and, usually, it is directly proportional to the alkalinity of water or the medium the formulation touches.

The microcapsules of this invention maintain insecticide active ingredients at an acid pH; thus, providing a greater resistance to alkalinity that other conventional paints offer.

b. Adherence.

Usually, outdoor paint adheres to materials such as concrete, cement and the rest of mineral components usually found on a façade or a wall but, sometimes, there are other materials where the adherence of this type of paint is not satisfactory. Pain is highly adherent, and the microcapsules of this invention do not interfere at all with this characteristic.

c. Resistance to the Outdoors.

With this property, the capacity of the formulation to maintain its properties facing all kinds of external abiotic agents (humidity, sun rays, temperature, pressure) and even biotic agents, such as microorganisms, fungus and other live beings is measured.

In the case of paint, all paints deteriorate when exposed to the outdoors. The most common effects are yellowing, cracking and also chalking (releasing surface powder). To measure the resistance to the outdoors, paint is exposed to “accelerated aging”, subjecting the sample to UV radiation, greater than usual, and variable humidity and temperature conditions.

d. Resistance to Temperature.

This property is especially important for insecticides that possess active ingredients of the pyrethroid family, as these quickly degrade at high temperatures. Due to its very formulation, our additive with microcapsules counts on a greater resistance to temperature than conventional insecticides in an individual form.

e. Resistance to Wet Rubbing.

This property, supplementary to resistance to water, indicates the washability degree a coating count on. It is also a way to measure the paint resistance in case intense rain takes place.

Studies and investigations on the existing pesticides were performed to determine which ones are able to interact with humans, domestic animals, farm animals but, especially, which has the power to repel and eliminate flying and crawling insects. Thanks to this, the optimal components for this development were determined and selected.

On the other hand, options were analyzed for the combination of several biocides and/or pesticides in this invention, to increase the effectiveness of insecticide paint, while increasing the useful life of active ingredients.

Within microencapsulation techniques, the inclusion method using dextrin and its by-products was discovered, and the advantages with conventional methods were much more efficient in the process. Only by using S-cyclodextrin, an advantage has been observed, as only by varying stirring, its inclusive power is 90% in relation to coacervation, using less additives, but the same stirring speed. Likewise, a performance over 99% has been obtained in the formation of microcapsules, by applying a solution method with organic solvents, and the release behavior is the same as ionic gelation.

According to the micrometric size of the biocide particle (between 1 and 5 microns) it can mix with all the paint, and a greater surface can be treated, and it is less detectable by insects, but they feel the effect when falling or moving away, depending on the insect. It has been observed that dextrin protects the biocide for a longer period, it neutralizes its toxicological profile to the environment, reducing its degradation in storage.

The cyclodextrin used as encapsulating agent is one of the current innovations in this filed, as the biocide, due to its chemical nature, needs a wat to control its effect, and due to its molecular weight, it requires a macromolecule to support it and allow its release without preventing its effect, and cyclodextrins have the effect of supporting, without interacting with, the active ingredient.

Cyclodextrins are also soluble un aprotic and polar solvents, such as dimethyl sulfoxide (DMS) and dimethyl formamide (DMF), and stable in neutral and basic solutions, but slowly and gradually in acid mediums, just as all polysaccharides and starches, in a solid state, they degrade at over 200° C.

The internal cavity of cyclodextrins is hydrophobic, so it can store smaller molecules (oils) that from compounds called host-guest, in which the host molecule is encapsulated by cyclodextrins, this proves that cyclodextrins can form crystalline compounds from organic guest molecules in a solid, liquid or even gas (air) state, which leads to molecules insoluble in water, which, through this action, become soluble without any changes to the chemistry of the guest molecule, as there is no covalent bond during the interaction between cyclodextrins and the molecule insoluble in water.

It was observed that cyclodextrins interact with organic-metallic compounds, such as ferrocene, arene complexes, allyl complexes and metallic complexes, as well as pyrethroid, nicotinoid and carbamate biocides, the most interesting characteristic of cyclodextrins is their capacity to form stable inclusion complexes with a wide variety of compounds, preferably, with a low molecular weight and medium weight, and whose nature is non-polar (hydrocarbons), and polar (carboxylic acids, amins, etc.).

The relevance of cyclodextrins related to polymeric systems for water purification is worth mentioning.

An advantage found when using cyclodextrins in encapsulation is the formation of polymeric chains obtained from inclusion complexes, which are extended chains, released from the influence of neighboring chains in the matrix-host channel walls. As a consequence, polymer-cyclodextrin inclusion complexes can be quite useful as a model to know the intrinsic contribution to the confinement of polymeric chains, and to go deeper into the knowledge of cooperative and intermolecular interactions that can explain the behavior of materials in a solid state.

### EXAMPLE 1

### Carbamate Microencapsulation Through Inclusion, Using β-Cyclodextrin

This new invention attains particles or microcapsules that are more homogeneous and even in size, which allows a better scattering within the very paint or any other vehicle selected, such as aerosol, acrylic varnish, bait for insects or any other way to attract plague control, it can even be used as a home repellent, and the extended release can be programmed in a relatively short period, but with a long-term persistence, without contaminating the environment. Also, it can be mixed with a pyrethroid agent and a programmed-release trigger.

Cyclodextrin, as a product derived from hexose or modified starch, has been used for the following technique, using the following amount: 0.1% to 0.5% of carbamate or, even better, 1.5% to 3% carbamate priorly dissolved in ethanol (25 ml) and scattered with 20 ml of NF 85 mineral oil, or a necessary volume of 35 ml of oil and an enhanced scattering of 25 ml of oil, with a constant stirring at intervals of 15 to 25 min, supported with an exact amount of nonyl phenol of 10 moles at a ratio of 2%, always enhanced at 4% and added to the previous beaker. Cyclodextrin is priorly scattered in distilled water with ethylic alcohol drops, and this solution is added to the previous beaker and constantly stirred at 6000 rpm, in intervals of 10 min to 20 min, to then filter and wash the microcapsules obtained or formed with a sodium hydroxide alkaline solution at 1%, then dried under the light. These microcapsules are added to the acrylic-based paint in amounts from 1% or, even better, 5% or 4% to 6% of the paint weight, and stirred until homogeneous paint is attained.

### EXAMPLE 2

### Carbamate Microencapsulation Through Simple Coacervation.

Carbamate is priorly dissolved and emulsified in an NF-10 solution, and added sodium alginate in a ratio of 2%-14%, it is diluted and stabilized, for a better performance, ratios of 2.9-14.5% are used, and an amount of 15-20 ml or more than 20-25 ml and a temperature of 45° C., then 40 to 50 ml of acetone are added, or 45-60 ml of acetone, and stirring continues for an interval of 10 minutes or, even better, 45 min, and then the product obtained is washed and rinsed, then the paint is added in average amounts of 2-25% or, even better, 3-37%, and it is stirred until full integration.

### EXAMPLE 3

### Carbamate Microencapsulation Through Complex Coacervation.

3% to 15% or 2.5% to 15% of gelatin are weighted or, even better 3% to 17% and dissolved in 50 ml of water heated to 45° C. or 40° C. or, even better, to 50° C., and this is stirred until the product is fully dissolved, trying to prevent foam and the formation of agglomerates and, in a different container with priorly measured 50 ml, 2.5%-15% of acacia gum is added, or 3%-24.5% and, even better, 3%-26% and this is scattered through soft stirring until a soft paste is formed, and this is added to the previous solution with a mechanical stirrer priorly installed. Once both solutions are integrated, this is stirred for 20 min and 3%-15%, even better, 3%-26% of diluted carbamate is added, and stirring continuous, making sure no foam is formed, until a stable emulsion is obtained. Stirring speed increases to 6000 rpm, and 2% to 13% or, even better, 2% to 13.5% of aldehyde is added, until full integration. Reactor phases are separated and the microcapsules previously formed are washed, dried and added to the acrylic paint in a ratio of 1%-18% or, even better, 1%-23% and it is even better to add 2% to 25% to obtain a fast and full repelling action.

### EXAMPLE 4

### Inclusion Through Dextrin-Chitosan-Melamine

For this technique, chelating agents with a high molecular weight are used, which are able to encapsulate the molecular structure of light oils, such as olive oil, within their structure, the following is performed: 1%-12% of weight or 3.5%-15% of weight in chitosan previously dissolved in water and catalyzed with 2 ml of acetic acid with proportional amounts of melamine in an amount of 2 #in weight to 14% or 15% to 25% of melamine previously scattered in NF 85 mineral oil. Carbamate is dissolved in 25-27 ml of alcohol or, even better, 35-40 ml, and it is added in this phase to the melamine and stirred for 15 min. Chitosan is added to this mix and fully integrated to then add water, according to the reaction requirements. Once a homogeneous mix is attained, glutaraldehyde is added, in a ratio of 1%-25% of weight or 2%-30% of weight, maintaining stirring at 4500 rpm or, even better, 6000 rpm reaching an average of 9000 rpm for a total reaction, and keep stirring for 30 min, until full scattering of the solution is attained, and for 45 minutes, as necessary. A sodium hydroxide solution is added at 1%, and calcium chloride at 5%, stirring for 15 minutes until globules are disaggregated, forming particles. The microcapsules obtained are washed and dried, acrylic paint is integrated at 1%-18% or, even better, 1%-25%, and it is even better to add 2% to 25% for proper functioning.

### EXAMPLE 5

### Melamine-Chitosan Microencapsulation

This technique consists in mixing, in a, equimolecular way, amounts of chitosan, 2%-20% of weight or 5%-30% of weight in chitosan previously dissolved in water and catalyzed with 2 ml of acetic acid or, even better, 10 ml, with proportional amounts of melamine in an amount of 2%-20% in weight or 4% or 50% of melamine previously scattered in NF 85 mineral oil. Carbamate is dissolved in 25-27 ml of alcohol or, even better, 35-40 ml, and it is added in this phase to the melamine and stirred for 15 min. Chitosan is added to this mix and fully integrated to then add water, according to the reaction requirements. Once a homogeneous mix is attained, glutaraldehyde is added, in a ratio of 1%-25% of weight or 2%-20% of weight and, even better 2.5%-30%, maintaining stirring at 4150 rpm or, even better, 6000 rpm reaching an average of 9000 rpm for a total reaction, keep stirring for 30 min, until full scattering of the solution is attained, and for 45 minutes, as necessary. A sodium hydroxide solution is added at 1%, and calcium chloride at 5%, stirring for 15 minutes until globules are disaggregated, forming particles. The microcapsules obtained are washed and dried, acrylic paint is integrated at 1%-35% or, even better, 1%-50%, and it is even better to add 2% to 50% for a proper functioning.

The invention has been described enough for a person with medium knowledge on the field to reproduce and obtain the results mentioned in the invention herein. Nevertheless, any person with skills in the technical field related to this invention is able to make adjustments that have not been described in the request herein. Nevertheless, if the application of these adjustments on a certain structure or the manufacturing process thereof, the matters stated in the following claims are required, such structures must be included within the scope of the invention.

1. Microcapsules with biocide for their incorporation in coatings such as paint or similar repellents and/or insecticides, characterized by containing carbamate alone or combined with a pyrethroid as active ingredient (biocide), where such microcapsules are designed for a greater stability and an extended release of the active ingredient.

2. Microcapsules with biocide for their incorporation in coatings, such as paint, or similar repellents and/or insecticides according to claim 1, characterized by such pyrethroid being deltamethrin.
Microcapsules with biocide for their incorporation in coatings, such as paint, or similar repellents and/or insecticides according to claim 1, characterized by including dextrin in their formulation and, specifically, cyclodextrins that offer support, without interacting with the active ingredient, generating an internal hydrophobic cavity, allowing the storage of smaller molecules with the active ingredient.

4. Microcapsules with biocide for their incorporation in coatings, such as paint, or similar repellents and/or insecticides according to claim 1, characterized by being produced through a method selected from an inclusion method using β-cyclodextrin or dextrin-chitosan-melamine, a simple coacervation method and a complex coacervation method.

5. Microcapsules with biocide for their incorporation in coatings, such as paint, or similar repellents and/or insecticides according to claim 1, characterized by being added to the coating in a ratio from 1% to 6% of the weight of the coating, from 1% to 25% of coating weight, from 1% to 50% of coating weight, or from 2% to 37% of coating weight.
